(19) United States
(12) Patent Application Publication
(10) Pub. No.: US 2002/0102153 A1
(43) Pub. Date: Aug. 1, 2002

(54) Livestock trailer with self-cleaning ramp

(76) Inventor: Johnny R. McElroy, Snyder, OK (US)

Correspondence Address: Phillip L. Free, Jr., Crowe & Dunlevy, P.C., 1800 Mid-America Tower, 20 North Broadway, Oklahoma City, OK, 73102-8273, US

(21) Appl. No.: 10/066,415

(22) Filed: Feb. 1, 2002

Related U.S. Application Data
(60) Provisional application No. 60/265,734, filed on Feb. 1, 2001.

(51) Int. Cl. B65G 69/28

(52) U.S. Cl. 414/537

(57) ABSTRACT

The present invention is directed to an apparatus and associated method for moving livestock from a lower level to an upper level of a storage or transport container. The apparatus preferably includes a hinge attached to the upper level and a ramp assembly connected to the hinge. As such, the ramp assembly is configured for pivotal movement about the hinge from a raised position to a lowered position in closer proximity with the lower level. Preferably, the ramp assembly includes a cleaning chute that is exposed when the ramp assembly is moved to the raised position. The present invention may also be embodied in a livestock transport that includes a loading floor and a cargo floor elevated above the loading floor. In such an embodiment, the ramp assembly is preferably connected to the cargo floor and configured for pivotal movement about a hinge.

### RELATED APPLICATIONS

This application claims priority to United States Provisional Application No. 60/265,734 filed Feb. 1, 2001, entitled “Livestock Trailer With Self-Cleaning Ramp.”

### FIELD OF THE INVENTION

The present invention relates generally to an improved apparatus for the transport of livestock. The invention more particularly relates to a self-cleaning loading ramp on a trailer which permits the loading of livestock into the trailer without the need for external ramps and chutes. The present invention also discloses a moveable divider for facilitating the loading and unloading of livestock from the trailer.

### BACKGROUND OF THE INVENTION

Over the years, animal transports, such as livestock trailers, have been the subject of numerous improvements and innovations. Modern livestock trailers are commercially available in a variety of sizes and are configured to meet the specialized needs of consumers. Despite the variations in design, most livestock trailers share common characteristics, including, for example, the method by which livestock are loaded into the trailer. Typically, the animals are driven from a corral into a loading chute located on the ground adjacent the corral. Once inside the chute, the animals are directed up a ramp into a rear portion of the livestock trailer.

Although effective, the above mentioned method of loading livestock onto a trailer requires “docking” the trailer against the chute and ramp. In areas without access to a chute, it may be necessary to load animals directly from the ground. It is generally known in the art of livestock management to use portable ramps and chutes in the transport of livestock. However, prior art chute designs are cumbersome, difficult to move and dangerous to the animals and operator during use.

In light of the foregoing, there exists a pressing need to develop a practical, safe, and easily operated means for ground-loading livestock.

### SUMMARY OF THE INVENTION

The present invention is directed to an apparatus and associated method for moving livestock from a lower level to an upper level in a storage or transport container. The apparatus preferably includes a hinge attached to the upper level and a ramp assembly connected to the hinge. As such, the ramp assembly is configured for pivotal movement about the hinge from a raised position to a lowered position in closer proximity with the lower level. Preferably, the ramp assembly includes a cleaning chute that is exposed when the ramp assembly is moved to the raised position.

The present invention may also be embodied in a livestock transport that includes a loading floor and a cargo floor elevated above the loading floor. In such an embodiment, the ramp assembly is preferably connected to the cargo floor and configured for pivotal movement about a hinge from a raised position to a lowered position in closer proximity with the loading floor. In this embodiment, it is also preferred that the ramp assembly include a cleaning chute.

### BRIEF DESCRIPTION OF THE DRAWINGS AND PHOTOGRAPHS

FIG. 1 is a partial side view of portion of a trailer in accordance with a preferred embodiment of the present invention showing the ramp assembly in a lowered position.

FIG. 2 is a rear elevational view of the trailer of FIG. 1 showing the ramp assembly in a lowered position and the divider curtain in an extended position.

FIG. 3 is a bottom plan view of the ramp assembly of FIG. 2.

FIG. 4 is a top plan view of the ramp assembly of FIG. 3.

FIG. 5 is a side elevational view of the ramp assembly of FIG. 4.

FIG. 6 is a partial side view of the trailer of FIG. 1 showing the ramp assembly in a raised position.

FIG. 7 is a partial side view of the trailer of FIG. 1 configured for dock-engagement showing the ramp assembly in a raised position and the ramp supports in retracted position.

FIG. 8 is a partial side view of the trailer of FIG. 7 showing the ramp assembly lowered to dock height and the ramp supports extended.

FIG. 9 is a rear elevational view of the trailer of FIG. 8, showing the ramp assembly lowered to dock-height and the ramp supports extended.

FIG. 10 is partial side view of the trailer of FIG. 9 showing the ramp assembly unfolded at the dock height and supported by the extended ramp supports.

FIG. 11 is a rear elevational view of the trailer of FIG. 10 showing the ramp assembly lowered to the loading floor and the ramp supports retracted.

FIG. 12 is a partial side view of the trailer of FIG. 11 showing the ramp assembly lowered to the loading floor and the ramp supports retracted.

### DETAILED DESCRIPTION OF THE PREFERRED EMBODIMENT

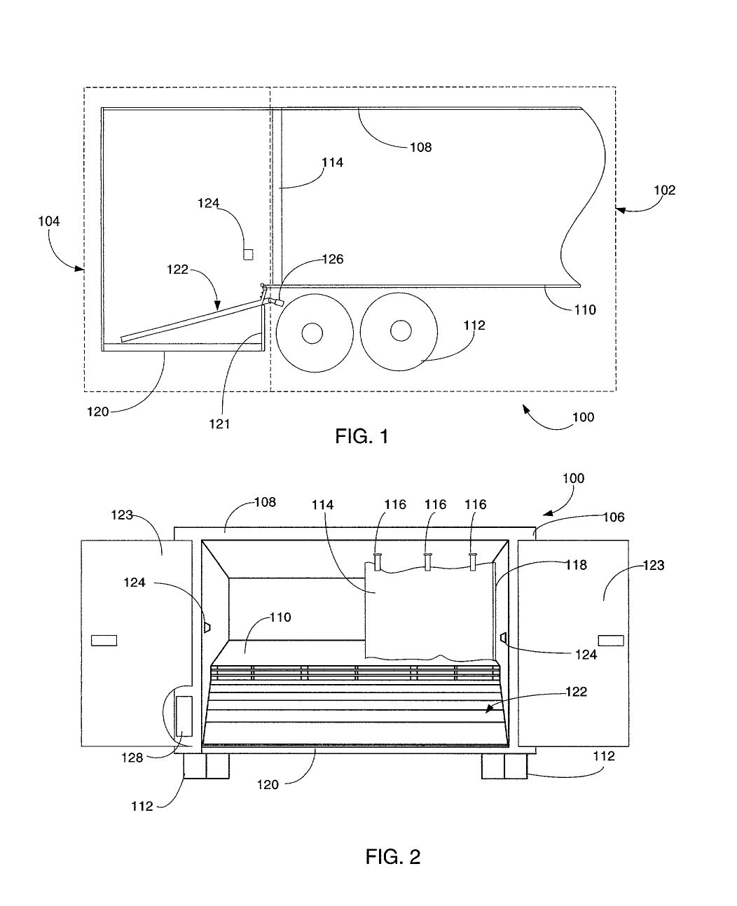

Referring to FIGS. 1 and 2, shown therein is a side elevational view of a portion of a livestock trailer 100 constructed in accordance with a preferred embodiment of the present invention. In the preferred embodiment, the trailer 100 is configured for use with a semi-tractor and includes a cargo portion 102 and a loading portion 104 at the opposing longitudinal end of the trailer. Also preferred is a trailer 100 which includes two rigid sidewalls 106 (removed from FIG. 1) and a rigid roof 108. Although the preferred embodiment of the present invention is described with reference to a semi-tractor trailer 100, it will be readily understood to one skilled in the art that the present invention may also be employed in a variety of other transports and enclosures, such as, for example, cargo holds for use in the marine transport of livestock.

The cargo portion 102 includes a cargo floor 110. In a presently preferred embodiment, the cargo floor 110 is located above a plurality of trailer wheels 112. The cargo portion 102 also includes a divider curtain 114. In a preferred embodiment of the present invention, the divider curtain is substantially rectangular and constructed from a flexible, multi-ply rubber. The top edge of the divider curtain 114 is secured to the roof 108 through use of a plurality of hinged mounts 116. A side edge of the divider curtain 114 is secured to a retaining flange 118 which, in turn, is affixed to the sidewall 106. Preferably, the bottom edge of the divider curtain 114 is in close proximity with the cargo floor 110. Also preferred is placement of the divider curtain 114 adjacent the loading portion 104 of the trailer 100 in a plane perpendicular to the longitudinal axis of the trailer 100. Although presently preferred embodiments of the present invention disclose rigidly affixing the retaining flange 118 to the sidewall 106, a hinged engagement is also contemplated as within the scope of the present invention. Additional alternative embodiments include making use of an “accordion-folded” divider which follows a plurality of guide-tracks along the cargo floor 110 and the roof 108.

Continuing with FIGS. 1 and 2, the loading portion 104 of the trailer 100 includes a loading floor 120. Preferably, the loading floor 120 is substantially parallel to the ground and located behind and below the center of the trailer wheels 112. A vertical face 121 connects the loading floor 120 and the cargo floor 110. The elevational difference between the cargo floor 110 and the loading floor 120 requires moving the cargo from a lower level to an upper level. Preferably, the loading floor 120 is in such proximity with the ground to enable livestock to easily step from the ground onto the loading floor 120 without use of an intermediate device, such as a ground-to-trailer ramp. The exact height selected for the loading floor 120 is a function of the physical characteristics of the livestock cargo and the ground clearance requirements of the trailer 100. External doors 123 are used to enclose the trailer 100. Although two external doors 123 are shown in FIG. 2, it will be understood that alternative door designs may also be used with the present invention. Such additional doors may include sliding, rolling or pivotally operated doors.

The loading portion 104 of the trailer 100 also includes a ramp assembly 122, a plurality of safety latches 124, a hydraulic cylinder 126 and remote controls 128. The structure, function and interrelation of these components will be discussed in greater detail below.

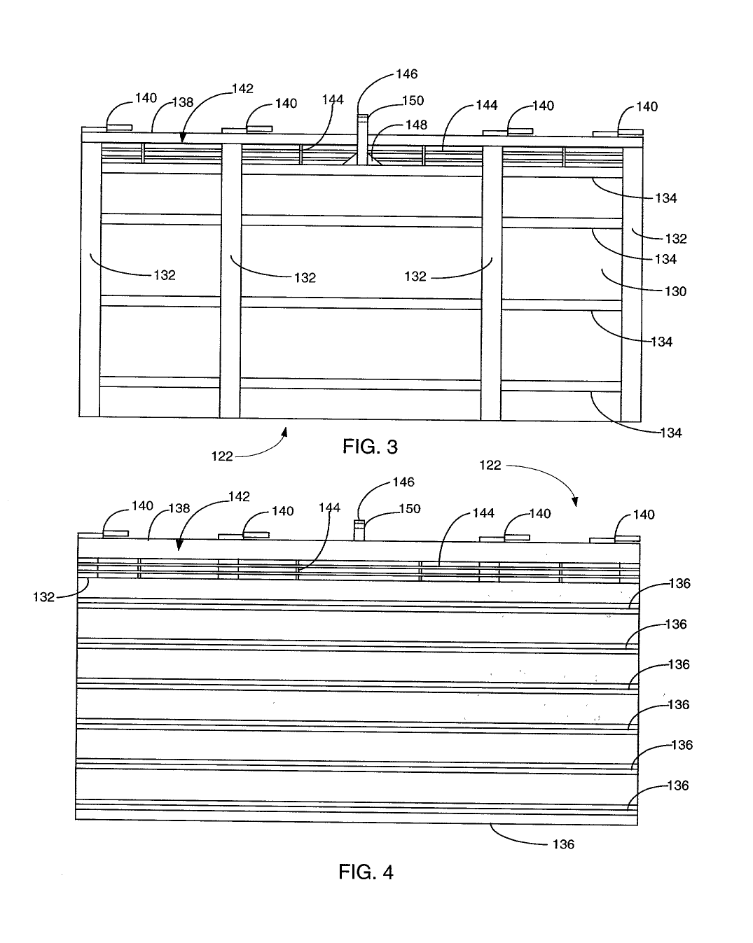

With reference now to FIGS. 3 and 4, shown therein are bottom and top plan views of the ramp assembly 122, respectively. In a preferred embodiment, the ramp assembly 122 has a substantially rectangular shape with dimensions that allow the ramp assembly 122 to be fully contained within the loading portion 104 of the trailer 100. The ramp assembly 122 includes a ramp floor 130 which is constructed from a plurality of longitudinal support members 132 and a plurality of lateral support members 134.

In a preferred embodiment of the present invention, the ramp floor 130 is constructed from a textured metal capable of repetitively supporting various amounts of weight imposed by livestock cargo. As shown in FIGS. 3 and 4, only the top side (see FIG. 4) of the ramp floor 130 is preferably textured. In an alternatively preferred embodiment, the ramp floor 130 is constructed from a semi-elastic composite material that exhibits desirable tractional qualities.

The ramp assembly 122 also includes a plurality of raised ridges 136 that extend vertically from the ramp floor 130 and which extend laterally across the width of the ramp floor 130. Preferably, the ridges 136 are constructed from metal strips that are affixed to the top surface of the ramp floor 130. Although the profile height of the ridges 136 may vary, a profile height of approximately one to four inches is preferred. Although six ridges 136 are shown in FIG. 4, it will be understood that alternative numbers of ridges 136 are encompassed within the scope of the present invention. The ridges 136, in addition to the textured surface of the ramp floor 130, provide increased traction during use of the ramp assembly 122.

The longitudinal and lateral support members 132, 134 are preferably constructed from a rigid, high strength metal and secured to the underside of the ramp assembly 122 through a welding process. Alternatively, the longitudinal and lateral support members 132, 134 may be attached to the ramp floor 130 using a plurality of fastening devices, such as, for example, clamps, brackets or bolts. In the presently preferred embodiment, the lateral support members 134 extend across the width of the ramp assembly 122. The longitudinal support members 132 extend across the length of the ramp floor 130.

The longitudinal support members 132 also support a laterally oriented ramp assembly hinge mount 138. At least one ramp assembly hinge 140 is supported by the ramp assembly hinge mount 138 and provides pivotal movement between the ramp assembly 122 and the cargo floor 110. Preferably, four ramp assembly hinges 140 are used to connect the ramp assembly 122 to the cargo floor 110, however, it will be readily understood that lesser or greater numbers of hinges may also be used. Furthermore, it will be understood that the ramp assembly 122 could also be hingedly connected to other parts of the trailer 100, such as the sidewalls 106 or the vertical face 121.

A cleaning chute 142 is defined by the absence of flooring between the ramp assembly hinge mount 138 and the ramp floor 130. A plurality of safety members 144 extend laterally and longitudinally across the cleaning chute 142 to form a grid that prevents the accidental entrapment of an animal's hoof or foot in the cleaning chute 142.

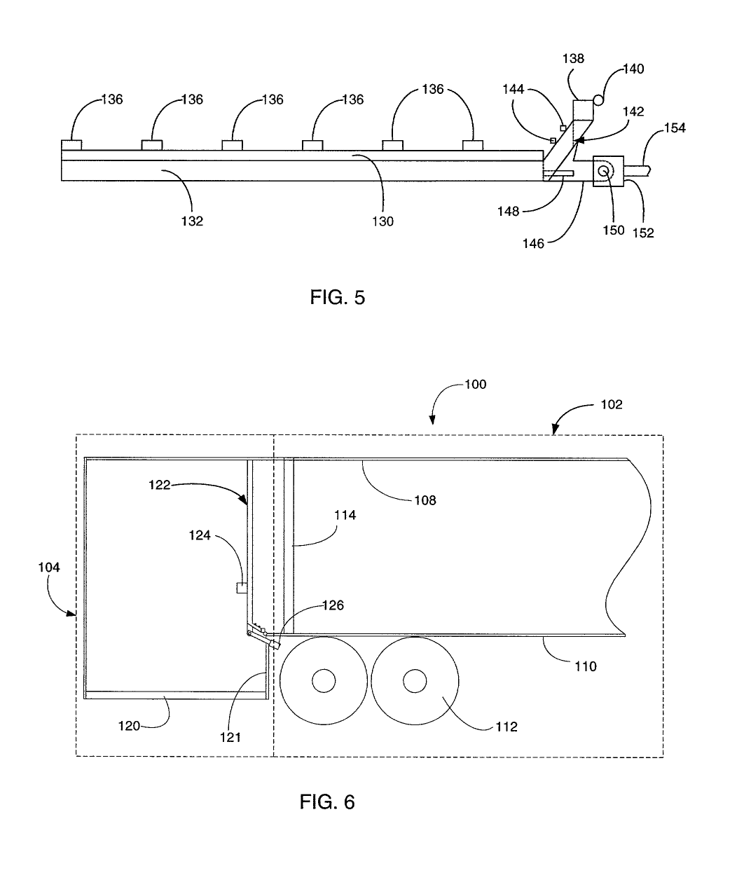

With continued reference to FIGS. 3 and 4, but with reference now also to FIG. 5, shown therein is a side elevational view of the ramp assembly 122. From FIG. 5, it is apparent that the ramp assembly hinge mount 138 is offset in elevation from the ramp floor 130 and that the longitudinal support members 132 are angled to support both the ramp assembly hinge mount 138 and the ramp floor 130. In the presently preferred embodiment, the ramp assembly hinge mount 138 is positioned relative the ramp floor 130 such that the longitudinal support members 132 must turn at approximately a 45 degree angle. However, alternative configurations of the ramp assembly 122 are also contemplated as within the scope of the present invention and include, for example, positioning the ramp assembly hinge mount 138 directly above the ramp floor 130 such that the longitudinal support members 132 would form a right angle in supporting the ramp floor 130 and the ramp assembly hinge mount 138.

Also shown in FIGS. 3, 4 and 5 is a ramp lever 146 attached at the center of one of the lateral support members 134. The ramp lever 146 is preferably supported by reinforcements 148 which are supported by the same lateral support member 134. The ramp lever 146 includes a lever bore 150 and is designed for pivotal engagement with a coupler 152. The coupler 152 includes a coupler bore 154 and is rigidly attached to the hydraulic cylinder 126. The coupler 152 matingly engages the ramp lever 146 and is held in place by a pin which is inserted through the coupler bore 154 and through the lever bore 150. The pin is held in place with a conventional lock-pin. Although a single combination of the ramp lever 146 and hydraulic cylinder 126 are shown, two or more such combinations may also be used with equal success. For example, the ramp assembly 122 may include two or three spaced-apart ramp levers that are each connected to a corresponding hydraulic cylinder. It will be understood that additional means of operably coupling the ramp lever 146 to the hydraulic cylinder 126 are also encompassed within the scope of the present invention.

Turning now to FIG. 6, shown therein is a side view of the trailer 100 with the ramp assembly 122 in a raised position. The latches 124 are preferably manually operated lever-action latches that, when engaged, restrict the motion of the raised ramp assembly 122. Although the presently preferred embodiment discloses a conventional lock-and-channel mechanical latch, other latches are also contemplated by the present invention and include, for example, electromechanical and electromagnetic latch mechanisms. Those of skill in the art will readily understand and appreciate the construction and operation of such latches.

The basic operation of the ground-loader embodiment is described below. At the onset of operation, livestock are gathered to a position adjacent the trailer 100. The ramp assembly 122 is lowered to a loading position in which the moveable end of the ramp assembly 122 is supported by the loading floor 120.

In sub-freezing weather conditions, animal deposits on the contact point between the ramp assembly 122 and the loading floor 120 may freeze, thereby prohibiting movement of the ramp assembly 122. To reduce the effects of sub-freezing temperatures, it may be desirable to minimize the contact area between the loading floor 120 and the ramp assembly 122 through use of “landing pads” (not shown). Preferably, the landing pads are fabricated from angle iron and provisioned orthogonal to the edge of the ramp assembly 122, such that there is minimal contact between the ramp assembly 122 and the loading floor 120. The landing pads should be disposed at regular intervals across the width of the loading floor 120. Alternatively, the landing pads can be constructed from a single piece of angle iron that extends parallel to the ramp assembly 122 across the width of the loading floor 120.

Next, if the trailer 100 makes use of a retractable divider curtain 114, the operator should fully extend the divider curtain 114. At this time, the operator may begin directing livestock onto the textured ramp floor 130. The livestock then climb the ramp assembly 122 and pass between the divider curtain 114 and the opposing sidewall 106 into the cargo portion 102 of the trailer 100. Extending the divider curtain 114 discourages the livestock from turning around while being loaded into the trailer 100. Once the livestock have been loaded into the cargo portion 102, the operator increases the fluid pressure in the hydraulic cylinder 126. It will be understood that conventional hydraulic plumbing, controls and pumps may be used to operate the hydraulic cylinder 126. As the hydraulic cylinder 126 expands, the force applied by the hydraulic cylinder on the ramp lever 146 causes the ramp assembly 122 to swing upward about the ramp assembly hinges 140. Once completely raised, the ramp assembly 122 is secured in its upright position through use of the safety latches 124. Should the hydraulic cylinder 126 experience a loss in fluid pressure, the raised ramp assembly 122 is retained in the raised position by the safety latches 124.

In the raised position, the ramp assembly 122 functions as a gate that separates the cargo portion 102 from the loading portion 104. Once separated, the loading portion 104 is available for the transportation of additional livestock. Alternatively, the loading portion 104 may be used for the storage of equipment during the transportation of the livestock. Any equipment stored in the loading portion 102 should be removed prior to lowering the ramp assembly 122. While storing equipment or livestock in the loading portion 104, the operator should ensure that the external doors 128 are closed and secured.

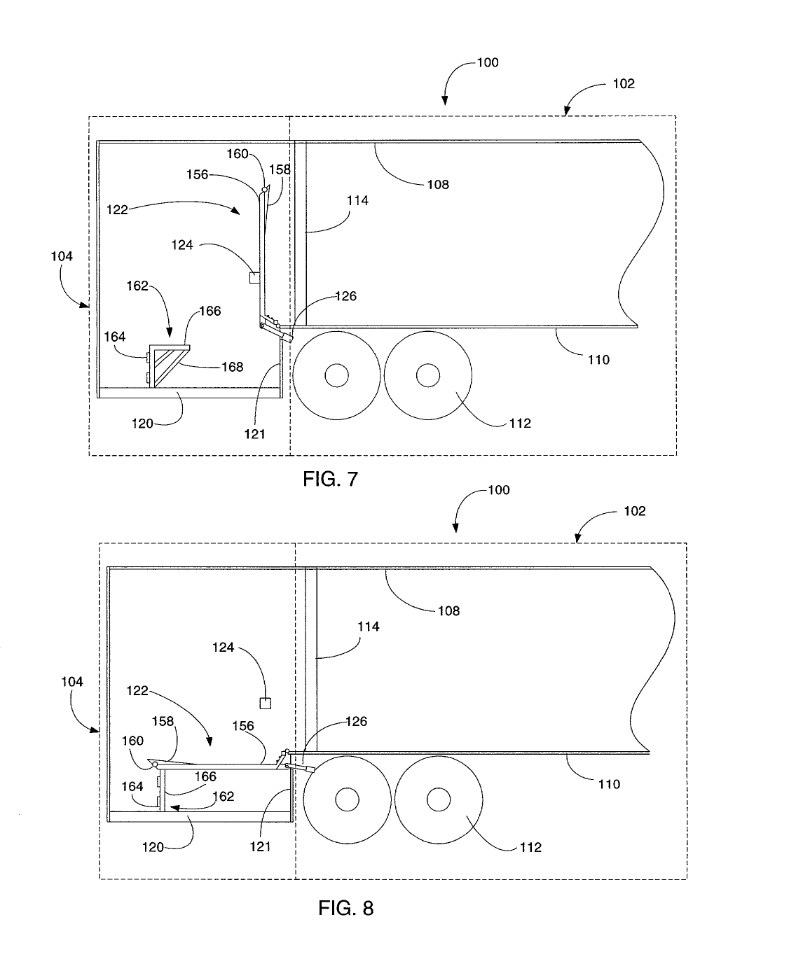

In addition to providing a means for ground-loading livestock into the trailer 100, the present invention also provides for compatible operation with conventional loading docks. Turning now to FIGS. 7 and 8, shown therein is a partial side view of the trailer 100 configured for use with an elevated loading dock. More specifically, the ramp assembly 122 is configured to be folded any number of times. In the presently preferred embodiment, the ramp assembly is configured for a bi-folding operation and includes a first portion 156 and a second portion 158. The first and second portions 156, 158 include those portions of the ramp assembly 122 that were described above, including the ramp floor 130, the longitudinal support members 132, the lateral support members 134 and the ridges 136.

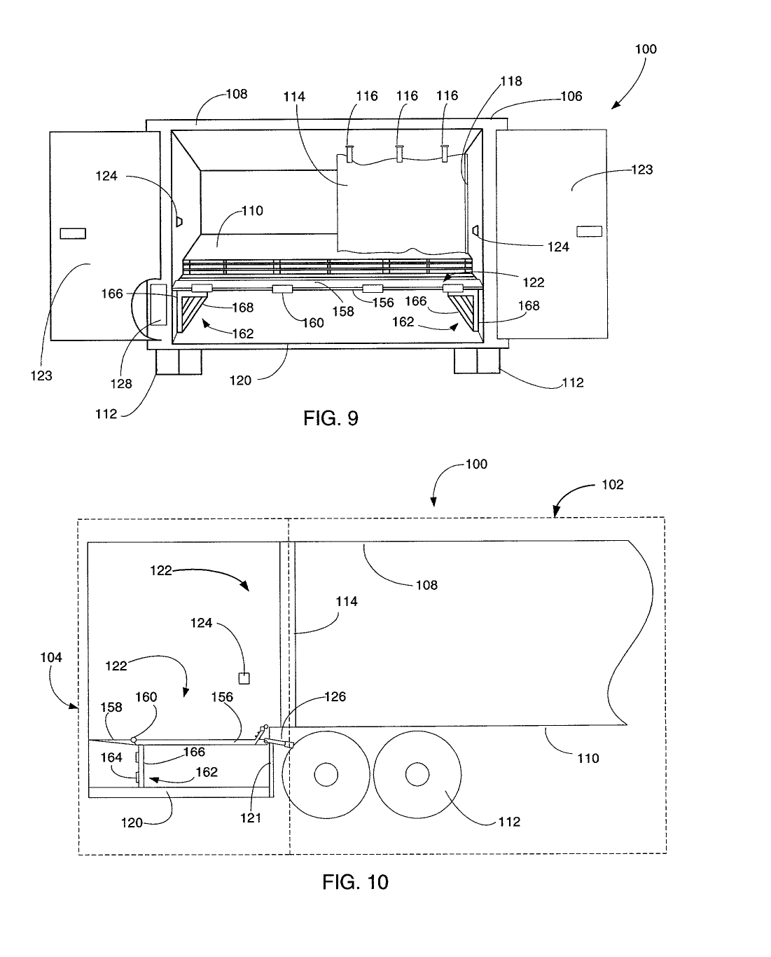

Turning now to FIGS. 9 and 10, shown therein are respective rear elevational and partial side views of the trailer 100 configured for the dock-loading embodiment. From FIGS. 9 and 10, it can be seen that the second portion 158 is attached to the first portion 156 through use of at least one ramp floor hinge 160. The ramp floor hinge 160 permits the second portion 158 to be unfolded from a position on top of the first portion 156 to a position adjacent the first portion 156. Preferably, the first portion 156 and the second portion 158 are manufactured for beveled engagement with one another. As such, the geometry of the engagement between the first and second portions 156, 158 restricts the second portion 158 from unfolding to a position beyond the extent at which the second portion is substantially “co-linear” with the first portion 156.

With continued reference to FIGS. 9 and 10, but also referring again to FIG. 7, shown therein are two ramp support assemblies 162 positioned within the loading portion 104 of the trailer 100. Preferably, a single ramp support assembly 162 is pivotally attached to each sidewall 106 through use of a at least one support hinge 164. The support hinge 164 enables the selective deployment of each ramp support assembly 162 from a retracted position parallel to the sidewalls 106 (FIG. 7) to an extended position perpendicular to the sidewalls 106 (FIGS. 9 and 10). Although two support hinges 164 are presently preferred, it will be understood that additional support hinges 164 could also be used with equal success.

The ramp support assemblies 162 include a frame 166 and a plurality of frame supports 168. The frame 166 is preferably configured to support the ramp assembly 122 at a “dock-height.” This can be achieved by varying the dimensions of the frame 166 or by mounting the frame 166 at a specified height on the respective sidewall 106. Variable height ramp support assemblies are also contemplated by the present invention and would enable selectively adjusting the “dock-height” of the ramp assembly 122. Such variable height ramp support assemblies include the use of hydraulically elevated supports and mechanically elevated supports. It will be understood that there are numerous designs of the ramp support assembly 162 and that these additional designs are also encompassed within the scope of the present invention.

FIG. 10 also demonstrates the interrelated function the ramp assembly 122 and the ramp support assembly 162. When the first portion 156 is lowered to dock height, the ramp assembly 122 is supported by the ramp support assemblies 162. Once supported, the second portion 158 can be fully unfolded to its position in col-linear alignment with the first portion 156. It will be readily understood that the swinging action of the secondary portion 158 can be manual or powered through use of, for example, an electric motor, a pneumatic piston or a hydraulic cylinder.

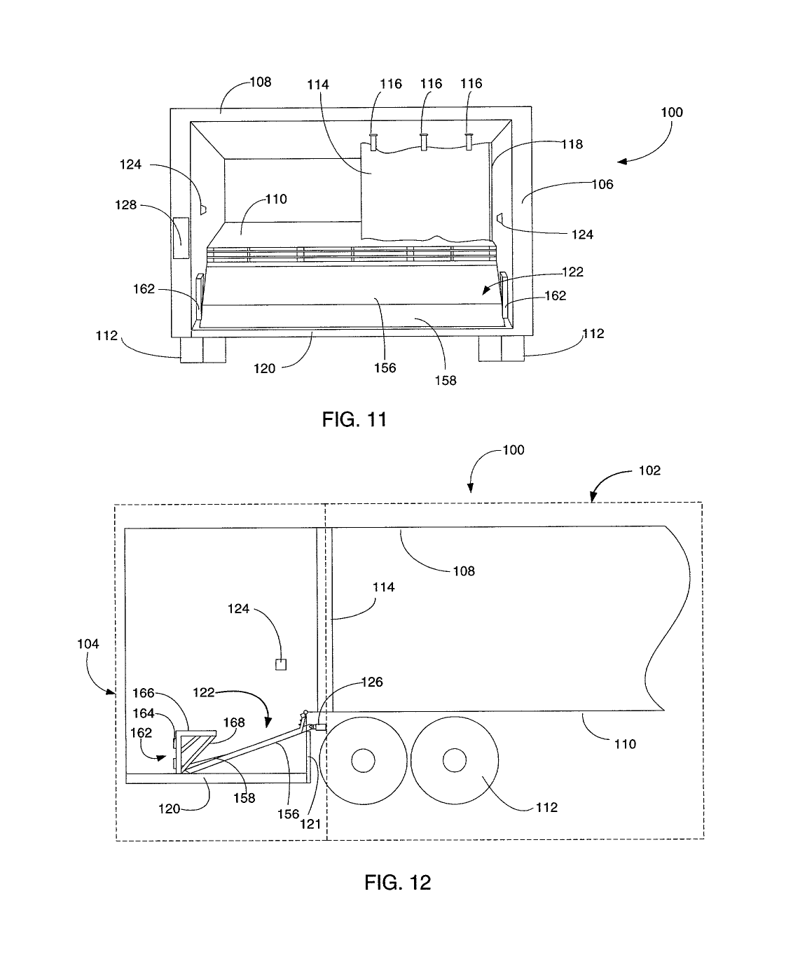

Turning now to FIGS. 11 and 12, shown therein are respective rear elevational and partial side views of the loading portion 104 of the trailer 100 (the external doors 123 have been removed from FIG. 11). From FIGS. 11 and 12, it can be seen that, when retracted, the ramp support assemblies 162 do not interfere with the operation of the ramp assembly 122. More particularly, when the ramp support assemblies 162 are retracted, the ramp assembly 122 is permitted to travel full stroke to the loading floor 120. As such, the ground-loader embodiment of the present invention can be practiced without encumbrance from the ramp support assemblies 162.

The basic operation of the dock-loading compatibility of the present invention is described below. At the onset of operation, the trailer is positioned adjacent a stationary loading dock (not shown). The operator extends the frame support assemblies 162 such that they are oriented substantially perpendicular to the sidewalls 106. Next, the operator, via the remote control 128, lowers the folded ramp assembly 122 onto the ramp support assemblies 162. Once positioned on top of the ramp support assemblies 162, the operator unfolds the second portion 158 from the first portion 156, thereby fully extending the ramp assembly 122. Preferably, the trailer 100 is positioned relative the stationary loading dock such that, when unfolded, the second portion 158 rests on top of the loading dock.

Next, the livestock are directed onto the ramp assembly 122 and pass between the sidewall 106 and the divider curtain 114 into the cargo portion 102. Once all of the livestock have been loaded, the operator folds the second portion 158 onto the first portion 156. The operator then increases the fluid pressure in the hydraulic cylinder 126, thereby causing the entire ramp assembly 122 to swing upward. Once vertical, the ramp assembly 122 is secured in position by the latches 124. The ramp support assemblies 162 are then retracted to increase the storage capacity of the loading portion 104 and the doors 123 are closed and secured.

Alternatively, the entire trailer 100 can be used for the storage of livestock. To make use of both the cargo portion 102 and loading portion 104, the ramp assembly 122 should remain in the loading position during transportation of the livestock. More specifically, if the livestock were ground-loaded, the ramp assembly 122 should remain in its lowered position, supported by the loading floor 120. Likewise, if the livestock were dock-loaded, the ramp assembly 122 should remain in the horizontal position, supported by the ramp support assemblies 162. In both cases, the livestock are retained within the trailer 100 during transportation by closing and securing external doors 123 (see FIG. 2). To unload, the livestock should be crowded into the cargo portion 104 of the trailer 100. The ramp assembly 122 can then be raised for engagement with a dock or lowered to the loading floor 120 for “no dock” unloading.

During use, the ramp assembly 122 may become covered with soil, manure and the like. When soiled, the ramp assembly 122 becomes slick and hazardous to the livestock and to the operator. To improve the safety of the trailer 100, it is therefore necessary to remove the debris from the ramp assembly 122.

As the ramp assembly 122 is raised, debris deposited by the livestock falls from the ramp floor 130 through the cleaning chute 142. The debris gathers on the loading floor 120 and is easily removed by the operator. The “self-cleaning” ramp assembly 122 advantageously reduces cleaning labor and improves the overall safety of the trailer 100.

Another advantage realized by the present invention is the minimization of “pinch-points” throughout the trailer 100. More particularly, the present invention reduces the chance of trapping an animal between stationary or moving components within the trailer 100. For example, because the ramp assembly 122 extends across the width of the loading portion 102, the chance of catching an animal's hoof in the small space between the sidewalls and the ramp assembly 122 is significantly reduced. The flexible divider curtain 114 also reduces the chance of pinching an animal, or some portion thereof, between the raised ramp assembly 122 and the divider curtain 114. Additionally, as mentioned above, the use of safety members 144 reduces the chance of catching an animal's hoof in the cleaning chute 142.

Yet another advantage of the present invention is the minimization of the risk of operator injury. Conventional trailers require that the operator be in close proximity with the livestock during loading and unloading, thereby compromising the safety of the operator. Because the loading mechanisms can be remotely operated via the remote control 128, the risk of injury to the operator is significantly lessened.

Still another advantage of the present invention is the versatility of operation of the trailer 100. When used in conjunction with the ramp support assemblies 162, the ramp assembly 122 can be configured to be folded and used in either ground-loading and unloading or dock-loading and unloading environments. This compatibility significantly increases the utility of the trailer 100, allowing the operator to ground-load livestock in the field while remaining compatible with conventional dock loading practices.

The present invention may also be advantageously employed in cattle transports that make use of multiple cargo levels. For example, a first ramp assembly 122 can be used to load the livestock onto the trailer and from the loading portion 104 to the cargo portion 102. In transports containing multiple cargo decks, a second ramp assembly 122 can be used to direct livestock from a lower cargo deck to an upper cargo deck. Once the upper cargo deck is full, the second ramp assembly 122 is raised, thereby enclosing the livestock on the upper cargo deck while at the same time permitting the passage of livestock into the lower cargo deck. Once the lower cargo deck is full, the first ramp assembly 122 is raised, thereby enclosing the livestock on the lower cargo deck and separating the loading portion 104 from the cargo portion 102.

It is clear that the present invention is well adapted to carry out its objectives and attain the ends and advantages mentioned above. While presently preferred embodiments of the invention have been described in varying detail for the purposes of disclosure, it will be understood that numerous changes may be made which will readily suggest themselves to those skilled in the art and which are encompassed within the spirit of the invention disclosed and as defined in the above text, in the accompanying drawings and in the appended claims.

It is claimed:

1. A livestock transport comprising:
a loading floor;
a cargo floor elevated above the loading floor;
a ramp assembly hinge attached proximate the cargo floor; and
a ramp assembly connected to the cargo floor and configured for pivotal movement about the ramp assembly hinge from a raised position to a lowered position in closer proximity with the loading floor, the ramp assembly having a ramp floor and a cleaning chute.

2. The livestock transport of claim 1, wherein the ramp assembly is substantially rectangular, and wherein the cleaning chute is located between the ramp floor and the ramp assembly hinge.

3. The livestock transport of claim 2, wherein the ramp floor and cleaning chute form an angled profile.

4. The livestock transport of claim 1, wherein the ramp floor and cleaning chute form an angle of at least 90°.

5. The livestock transport of claim 1, wherein the ramp floor includes at least one raised ridge that traverses the ramp floor.

6. The livestock transport of claim 1, wherein the ramp assembly further comprises a ramp lever located below the ramp assembly hinge, and wherein the pivotal movement of the ramp assembly is effected by application of force to the ramp lever.

7. The livestock transport of claim 5, wherein the force applied to the ramp assembly is provided by a hydraulic cylinder.

8. The livestock transport of claim 1, wherein the pivotal movement of the ramp assembly is controlled through use of a remote control.

9. The livestock trailer of claim 1, further comprising:
a sidewall; and
a divider curtain attached to the sidewall.

10. The livestock transport of claim 9, wherein the divider curtain is retractable.

11. The livestock trailer of claim 1, wherein the ramp floor comprises:
a ramp floor hinge;
a first portion attached to the ramp floor hinge; and
a second portion attached to the ramp floor hinge;
wherein the first and second portions are configured for folding operation.

12. The livestock transport of claim 11, further comprising a ramp support assembly, wherein the ramp assembly is supported by the ramp support assembly when lowered from the raised position.

13. The livestock transport of claim 12, wherein the ramp support assembly is configured for selective deployment.

14. A livestock transport comprising:
a cargo portion;
a loading portion; and
means for permitting the movement of livestock from the loading portion to the cargo portion.

15. An apparatus for moving livestock from a lower level to an upper level, the apparatus comprising:
a ramp assembly hinge attached proximate the upper level; and
a ramp assembly connected to the ramp assembly hinge and configured for pivotal movement about the ramp assembly hinge from a raised position to a lowered position in closer proximity with the lower level, the ramp assembly having a ramp floor; and a cleaning chute.

16. The apparatus of claim 15, wherein the ramp assembly is substantially rectangular, and wherein the ramp floor is adjacent and connected to the cleaning chute and the cleaning chute is attached to the ramp assembly hinge.

17. The apparatus of claim 16, wherein the connection between the ramp floor and cleaning chute forms an angled profile.

18. The apparatus of claim 17, wherein the connection between the ramp floor and cleaning chute forms an angled profile having an angle not less than 90°.

19. The apparatus of claim 15, wherein the ramp floor includes at least one raised ridge that traverses the ramp floor.

20. The apparatus of claim 15, wherein the ramp assembly further comprises a ramp liver located below the ramp assembly hinge, and wherein the pivotal movement of the ramp assembly is effected by application of force to the ramp lever.

21. The apparatus of claim 20, wherein the force applied to the ramp lever is provided by a hydraulic cylinder.

22. The apparatus of claim 15, wherein the pivotal movement of the ramp assembly is controlled through use of a remote control.

23. The apparatus of claim 15, wherein the ramp floor comprises:
a ramp floor hinge;
a first portion attached to the ramp floor hinge;
a second portion attached to the ramp floor hinge; and
wherein the first and second portions are configured for folding operation.

24. The apparatus of claim 23, further comprising a ramp support assembly, wherein the ramp assembly is supported by the ramp support assembly when lowered from the raised position.

25. The apparatus of claim 15, further comprising a ramp support assembly, wherein the ramp assembly is supported by the ramp support assembly when lowered from the raised position.

26. A method for loading livestock from the ground to a transport and unloading the livestock from the transport, wherein the transport includes a loading floor, a cargo floor, a first sidewall and a second sidewall, the method comprising the following steps:
(A) lowering a ramp assembly from a raised position to a lowered position in contact with the loading floor;
(B) forcing the livestock from the ground directly onto the loading floor;
(C) directing the livestock from the loading floor up the ramp assembly;
(D) directing the livestock from the ramp assembly into the cargo portion;
(E) raising the ramp assembly;
(F) moving the livestock transport to the elevated dock;
(G) deploying a ramp support assembly;
(H) lowering the ramp assembly; and
(I) unloading the livestock to the elevated dock across the ramp assembly.

27. The method of claim 26, wherein the transport further includes a first sidewall and a second sidewall, and wherein the method further comprises the additional step of:
extending a divider curtain across a portion of the transport prior to step B, wherein the divider curtain is attached to the first sidewall between the loading floor and the cargo floor.

28. The method of claim 27, wherein step (D) of the method further comprises:
directing the livestock between the extended divider curtain and the second sidewall.

29. The method of claim 26, wherein the ramp assembly comprises a cleaning chute, and wherein the method further comprises the step of:
(J) cleaning the ramp assembly by raising the ramp assembly.

30. The method of claim 26, wherein the ramp assembly is raised through use of a remote control.

31. The method of claim 26, wherein the ramp assembly is lowered until it is supported by a ramp support assembly.

32. The method of claim 31, wherein the ramp assembly includes a ramp hinge and wherein the ramp assembly is unfolded.
